(19) United States
(12) Patent Application Publication
(10) Pub. No.: US 2018/0269589 A1
(43) Pub. Date: Sep. 20, 2018

(54) DUAL-POLARIZED ANTENNA

(71) Applicant: Huawei Technologies Co., Ltd., Shenzhen (CN)

(72) Inventors: Tingwei XU, Shenzhen (CN); Yaoqun WU, Shenzhen (CN); Yujiang WU, Shenzhen (CN)

(21) Appl. No.: 15/982,873

(22) Filed: May 17, 2018

Related U.S. Application Data
(63) Continuation of application No. PCT/CN2016/106162, filed on Nov. 16, 2016.

(30) Foreign Application Priority Data
Nov. 20, 2015 (CN) 201510812761.1

(51) Int. Cl. H01Q 19/17; H01Q 21/06; H01Q 9/28; H01Q 1/38; H01Q 9/04; H01Q 15/18

(52) U.S. Cl. CPC H01Q 19/17; H01Q 21/062; H01Q 15/18; H01Q 1/38; H01Q 9/0407; H01Q 9/285

(57) ABSTRACT

Embodiments of the present disclosure provide a dual-polarized antenna. The dual-polarized antenna in the present disclosure includes two orthogonally arranged dipole units and a metal reflector. Each dipole unit includes two radiation arms and a balun structure, a preset angle is formed between the radiation arm and the balun structure, the radiation arm is connected to one end of the balun structure, and the metal reflector has a hollow-out structure. The metal reflector is disposed below the radiation arms, and the other end of the balun structure of each of the two dipole units passes through the hollow-out structure and is unconnected to the metal reflector. According to the embodiments of the present disclosure, antenna structure design is simplified, manufacturing processes are decreased, and a passive inter-modulation (PIM) risk is avoided.

### CROSS-REFERENCE TO RELATED APPLICATIONS

This application is a continuation of International Application No. PCT/CN2016/106162, filed on Nov. 16, 2016, which claims priority to Chinese Patent Application No. 201510812761.1, filed on Nov. 20, 2015, the disclosures of which are incorporated herein by reference in their entireties.

### TECHNICAL FIELD

Embodiments of the present disclosure relate to communications technologies, and in particular, to a dual-polarized antenna.

### BACKGROUND

Currently, a wide beam application scenario is required for a base station antenna in practice. For example, a 90-degree or 120-degree wide beam antenna is required in an area in which base stations are sparsely distributed, a traffic volume is small, or wide coverage is required.

In the industry, mainly two methods are used to improve an antenna to obtain a wide beam. One method is to change a side shape of a reflection panel of an antenna. Such design has a special requirement for a bent shape of the reflection panel. Generally, the reflection panel needs to be bent multiple times. Consequently, manufacturing becomes more difficult, and a precision requirement is higher than that for a reflection panel in a common shape. The other method is to bend a reflection panel to form a boss, and dispose a high-frequency dipole on the boss to lift an antenna element to obtain a wide beam. Because in such design the reflection panel needs to be fixedly bent to form a boss shape, a manufacturing process is added. In addition, a feeding structure needs to be soldered on a back side of the boss. Consequently, operating space is narrow, and it is inconvenient to perform assembly, maintenance, and disassembly.

### SUMMARY

Embodiments of the present disclosure provide a dual-polarized antenna, so as to simplify antenna structure design, decrease manufacturing processes, and avoid a passive inter-modulation (PIM) risk.

According to one aspect, a dual-polarized antenna includes: two orthogonally arranged dipole units and a metal reflector; where

each dipole unit includes two radiation arms and a balun structure, a preset angle is formed between the radiation arm and the balun structure, the radiation arm is connected to one end of the balun structure, and the metal reflector has a hollow-out structure; and

the metal reflector is disposed below the radiation arms, and the other end of the balun structure of each of the two dipole units passes through the hollow-out structure and is unconnected to the metal reflector.

In one embodiment, each dipole unit is a symmetrical dipole, and one end of each of the two radiation arms of the symmetrical dipole is connected to one end of the balun structure.

In another embodiment, each dipole unit is a folded dipole, and one end of each of the two radiation arms of the folded dipole is connected to one end of the balun structure.

In one embodiment, a length of the balun structure is 0.5 to 1 times a wavelength of an intermediate frequency of an operating band of the antenna.

In one embodiment, a distance between the metal reflector and each of the radiation arms of the two dipole units is 0.15 to 0.35 times the wavelength of the intermediate frequency of the operating band of the antenna.

In one embodiment, the dipole unit includes a feeding structure, and the feeding structure is connected to a feeding network.

In one embodiment, the metal reflector includes a planar structure and four side structures, the four side structures each is connected to the planar structure, and an angle is formed between the planar structure and each of the four side structures.

In one embodiment, the planar structure and the side structures may be quadrilateral, and each of the four side structures may be connected to one side of the planar structure.

In one embodiment, the angle is 60 to 150 degrees.

In one embodiment, a metal plate is disposed above or below the metal reflector, the metal plate is connected to the balun structures of the two dipole units, and the metal plate is unconnected to the metal reflector.

In one embodiment, the metal plate is made of a metal material or a printed circuit board (PCB) material covered with copper on a surface.

In the embodiments of the present disclosure, a structure of the dual-polarized antenna is simple in design, and it is easy to obtain a wide beam. Moreover, a manufacturing process is simple, and the dual-polarized antenna is easy to assemble, so that the dual-polarized antenna is suitable for mass production. In addition, because the metal reflector is unconnected to the dipole units, a PIM risk can be avoided.

### BRIEF DESCRIPTION OF DRAWINGS

To describe the technical solutions in the embodiments of the present disclosure more clearly, the following briefly describes the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1A is a schematic three-dimensional diagram of a dual-polarized antenna according to one embodiment;

FIG. 1B is a side perspective view of a dual-polarized antenna according to one embodiment;

FIG. 1C is a top view of a dual-polarized antenna according to one embodiment;

FIG. 2A is another schematic three-dimensional diagram of a dual-polarized antenna according to one embodiment;

FIG. 2B is a schematic three-dimensional diagram of a metal reflector of a dual-polarized antenna according to one embodiment;

FIG. 3A is still another schematic three-dimensional diagram of a dual-polarized antenna according to one embodiment;

FIG. 3B is a schematic three-dimensional diagram of a metal reflector of a dual-polarized antenna according to one embodiment; and

FIG. 4 is yet another schematic three-dimensional diagram of a dual-polarized antenna according to one embodiment.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

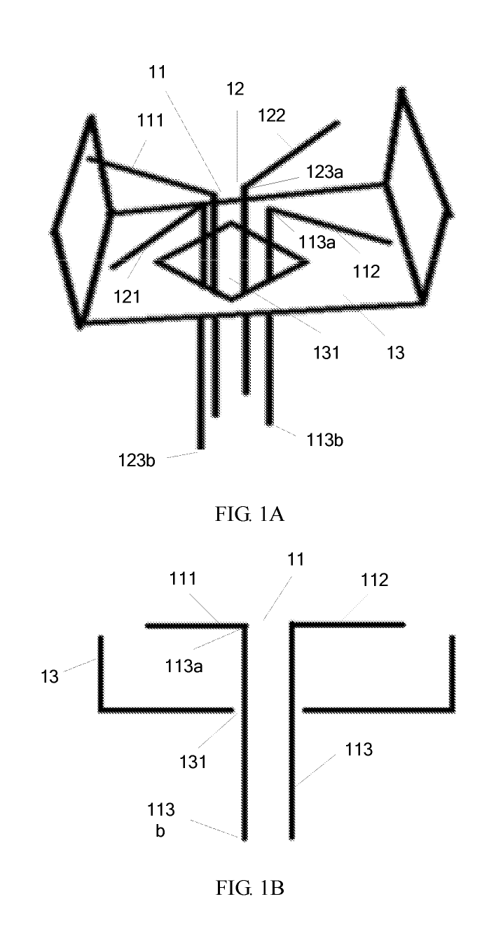

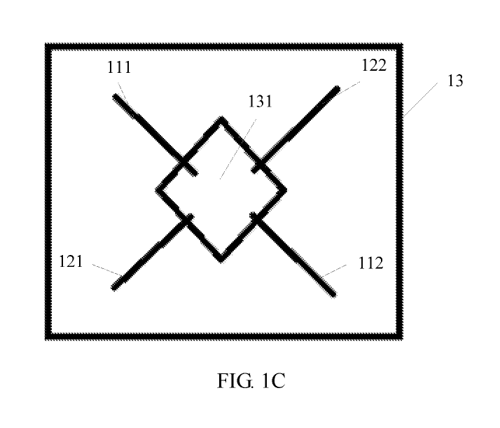

FIG. 1A is a schematic three-dimensional diagram of a dual-polarized antenna according to one embodiment, FIG. 1B is a side perspective view of the dual-polarized antenna according to this embodiment, and FIG. 1C is a top view of the dual-polarized antenna according to this embodiment. With reference to FIG. 1A, FIG. 1B, and FIG. 1C, the dual-polarized antenna in this embodiment may include two dipole units 11 and 12 and a metal reflector 13. The dipole units 11 and 12 are orthogonally arranged. The dipole unit 11 includes two radiation arms 111 and 112 and a balun structure 113. A preset angle is formed between the balun structure 113 and each of the radiation arms 111 and 112, and the radiation arms 111 and 112 are connected to one end 113a of the balun structure 113. The dipole unit 12 includes two radiation arms 121 and 122 and a balun structure 123. A preset angle is formed between the balun structure 123 and each of the radiation arms 121 and 122, and the radiation arms 121 and 122 are connected to one end 123a of the balun structure 123. The metal reflector 13 includes a hollow-out structure 131. The metal reflector 13 is disposed below the four radiation arms 111, 112, 121, and 122. The other end 113b of the balun structure 113 of the dipole unit 11 and the other end 123b of the balun structure 123 of the dipole unit 12 each passes through the hollow-out structure 131 and is unconnected to the metal reflector 13.

In this embodiment, a structure of the dual-polarized antenna is simple in design, and it is easy to obtain a wide beam. Moreover, a manufacturing process is simple, and the dual-polarized antenna is easy to assemble, so that the dual-polarized antenna is suitable for mass production. In addition, because the metal reflector is unconnected to the dipole units, a PIM risk can be avoided.

Further, in one embodiment, a length of each of the balun structures 113 and 123 is 0.5 to 1 times a wavelength of an intermediate frequency of an operating band of the dual-polarized antenna.

Further, in one embodiment, a distance between the metal reflector 13 and each of the two radiation arms 111 and 112 of the dipole unit 11 and the two radiation arms 121 and 122 of the dipole unit 12 is 0.15 to 0.35 times the wavelength of the intermediate frequency of the operating band of the dual-polarized antenna.

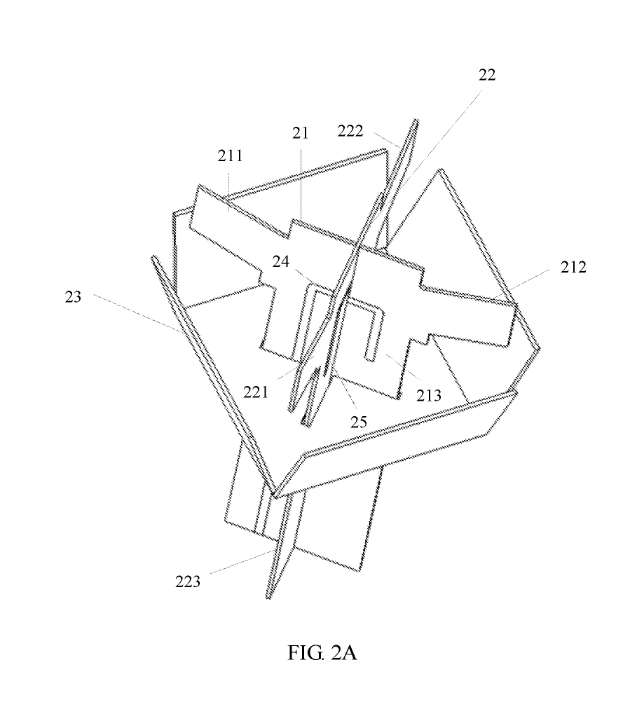

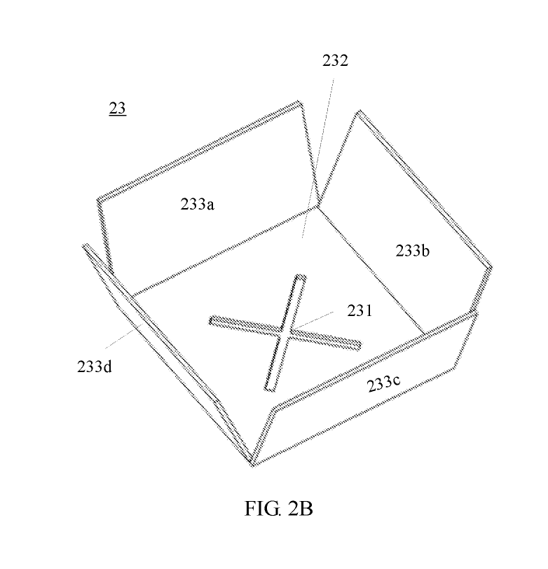

FIG. 2A is another schematic three-dimensional diagram of a dual-polarized antenna according to one embodiment, and FIG. 2B is a schematic three-dimensional diagram of a metal reflector of the dual-polarized antenna according to this embodiment. With reference to FIG. 2A and FIG. 2B, the dual-polarized antenna in this embodiment may include two dipole units 21 and 22 and a metal reflector 23. The dipole units 21 and 22 are orthogonally arranged. The dipole unit 21 is a symmetrical dipole, and the symmetrical dipole includes two radiation arms 211 and 212 and a balun structure 213. One end of each of the two radiation arms 211 and 212 is connected to one end of the balun structure 213, to form a preset angle. The dipole unit 22 is a symmetrical dipole, and the symmetrical dipole includes two radiation arms 221 and 222 and a balun structure 223. One end of each of the two radiation arms 221 and 222 is connected to one end of the balun structure 223, to form a preset angle. The metal reflector 23 includes a hollow-out structure 231. The metal reflector 23 is disposed below the four radiation arms 211, 212, 221, and 222. The other end of the balun structure 213 of the dipole unit 21 and the other end of the balun structure 223 of the dipole unit 22 each passes through the hollow-out structure 231 and is unconnected to the metal reflector 23.

The metal reflector 23 includes a planar structure 232 and four side structures 233a, 233b, 233c, and 233d. The four side structures 233a, 233b, 233c, and 233d each is connected to the planar structure 232, and an angle is formed between the planar structure 232 and each of the four side structures 233a, 233b, 233c, and 233d. In one embodiment, the angle may be 60 to 150 degrees. In one embodiment, the planar structure 232 and the four side structures 233a, 233b, 233c, and 233d may be all quadrilateral, and each of the four side structures 233a, 233b, 233c, and 233d is connected to one side of the planar structure 232.

In addition, feeding structures 24 and 25 are respectively disposed on the dipole units 21 and 22. The feeding structures 24 and 25 are connected to a feeding network, so as to feed the dual-polarized antenna.

In this embodiment, a structure of the dual-polarized antenna is simple in design, and it is easy to obtain a wide beam. Moreover, a manufacturing process is simple, and the dual-polarized antenna is easy to assemble, so that the dual-polarized antenna is suitable for mass production. In addition, because the metal reflector is unconnected to the dipole units, a PIM risk can be avoided.

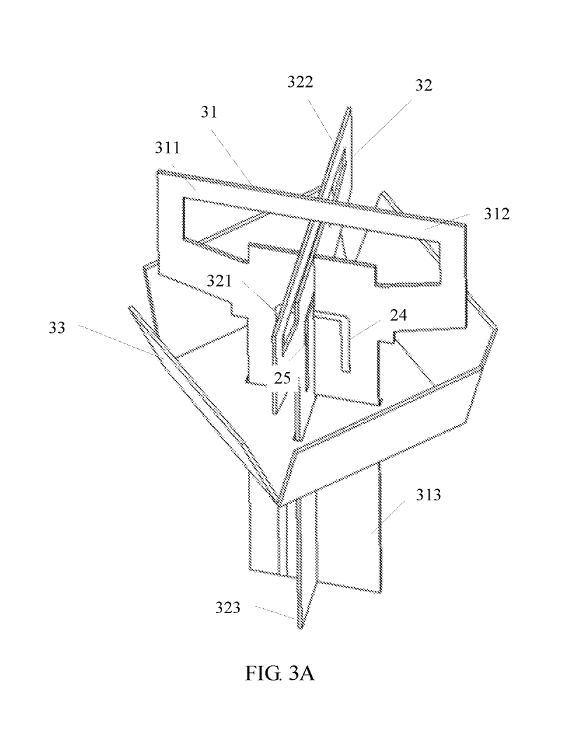

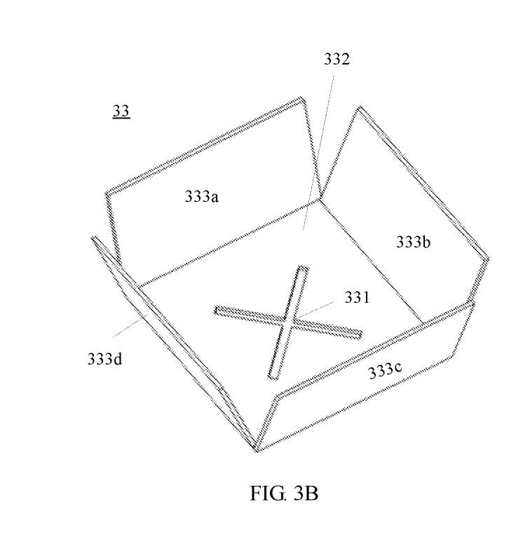

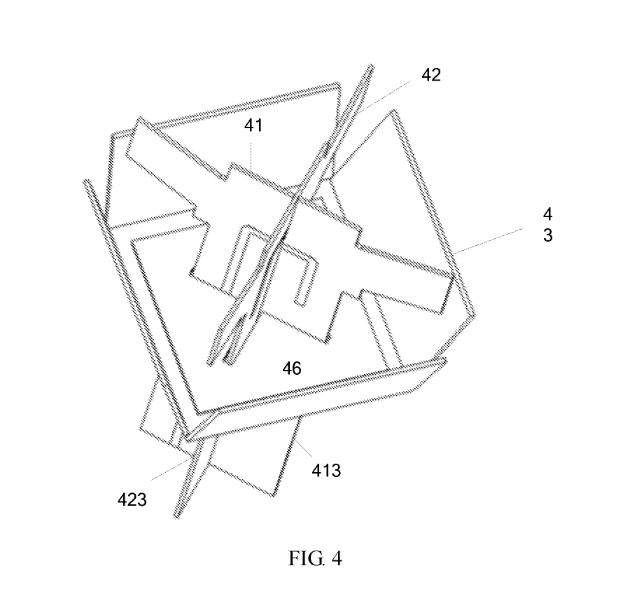

FIG. 3A is still another schematic three-dimensional diagram of a dual-polarized antenna according to one embodiment, and FIG. 3B is a schematic three-dimensional diagram of a metal reflector of the dual-polarized antenna according to this embodiment. With reference to FIG. 3A and FIG. 3B, the dual-polarized antenna in this embodiment may include two dipole units 31 and 32 and a metal reflector 33. The dipole units 31 and 32 are orthogonally arranged. The dipole unit 31 is a folded dipole, and the folded dipole includes two radiation arms 311 and 312 and a balun structure 313. One end of each of the two radiation arms 311 and 312 is connected to one end of the balun structure 313 to form a preset angle. The dipole unit 32 is a folded dipole, and the folded dipole includes two radiation arms 321 and 322 and a balun structure 323. One end of each of the two radiation arms 321 and 322 is connected to one end of the balun structure 323 to form a preset angle. The metal reflector 33 includes a hollow-out structure 331. The metal reflector 33 is disposed below the four radiation arms 311, 312, 321, and 322. The other end of the balun structure 313 of the dipole unit 31 and the other end of the balun structure 323 of the dipole unit 32 each passes through the hollow-out structure 331 and is unconnected to the metal reflector 33.

The metal reflector 33 includes a planar structure 332 and four side structures 333a, 333b, 333c, and 333d. The four side structures 333a, 333b, 333c, and 333d each is connected to the planar structure 332, and an angle is formed between the planar structure 332 and each of the four side structures 333a, 333b, 333c, and 333d. In one embodiment, the angle may be 60 to 150 degrees. In one embodiment, the planar structure 332 and the four side structures 333a, 333b, 333c, and 333d may be all quadrilateral, and each of the four side structures 333a, 333b, 333c, and 333d is connected to one side of the planar structure 332.

In addition, feeding structures 34 and 35 are respectively disposed on the dipole units 31 and 32. The feeding structures 34 and 35 are connected to a feeding network, so as to feed the dual-polarized antenna.

In this embodiment, a structure of the dual-polarized antenna is simple in design, and it is easy to obtain a wide beam. Moreover, a manufacturing process is simple, and the dual-polarized antenna is easy to assemble, so that the dual-polarized antenna is suitable for mass production. In addition, because the metal reflector is unconnected to the dipole units, a PIM risk can be avoided.

FIG. 4 is yet another schematic three-dimensional diagram of a dual-polarized antenna according to one embodiment. As shown in FIG. 4, a metal plate 46 is disposed above a metal reflector 43. The metal plate 46 is connected to a balun structure 413 of a dipole unit 41 and a balun structure 423 of a dipole unit 42, and the metal plate 46 is unconnected to the metal reflector 43. The metal plate 46 may be made of a metal material or a PCB material covered with copper on a surface. In one embodiment, the metal plate 46 may be disposed below the metal reflector 43. Addition of the metal plate can lead a current on the balun structure to the reflector, so as to improve symmetry of a direction pattern.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A dual-polarized antenna, comprising: two orthogonally arranged dipole units and a metal reflector; wherein
each dipole unit comprises two radiation arms and a balun structure, a preset angle is formed between the radiation arm and the balun structure, the radiation arm is connected to one end of the balun structure, and the metal reflector has a hollow-out structure; and
the metal reflector is disposed below the radiation arms, and the other end of the balun structure of each of the two dipole units passes through the hollow-out structure and is unconnected to the metal reflector.

2. The antenna according to claim 1, wherein each dipole unit is a symmetrical dipole, and one end of each of the two radiation arms of the symmetrical dipole is connected to one end of the balun structure.

3. The antenna according to claim 1, wherein each dipole unit is a folded dipole, and one end of each of the two radiation arms of the folded dipole is connected to one end of the balun structure.

4. The antenna according to claim 1, wherein a length of the balun structure is 0.5 to 1 times a wavelength of an intermediate frequency of an operating band of the antenna.

5. The antenna according to claim 1, wherein a distance between the metal reflector and each of the radiation arms of the two dipole units is 0.15 to 0.35 times the wavelength of the intermediate frequency of the operating band of the antenna.

6. The antenna according to claim 1, wherein the dipole unit comprises a feeding structure, and the feeding structure is connected to a feeding network.

7. The antenna according to claim 1, wherein the metal reflector comprises a planar structure and four side structures, the four side structures each is connected to the planar structure, and an angle is formed between the planar structure and each of the four side structures.

8. The antenna according to claim 7, wherein the planar structure and the four side structures are all quadrilateral, and each of the four side structures is connected to one side of the planar structure.

9. The antenna according to claim 7, wherein the angle formed between the planar structure and each of the four side structures is 60 to 150 degrees.

10. The antenna according to claim 1, wherein a metal plate is disposed above or below the metal reflector, the metal plate is connected to the balun structures of the two dipole units, and the metal plate is unconnected to the metal reflector.

11. The antenna according to claim 10, wherein the metal plate is made of a metal material or a printed circuit board (PCB) material covered with copper on a surface.
